(19) United States
(12) Patent Application Publication
(10) Pub. No.: US 2011/0311800 A1
(43) Pub. Date: Dec. 22, 2011

(54) MICROSTRUCTURE AND MICROSTRUCTURE PRODUCTION METHOD

(75) Inventors: Kosuke YAMASHITA, Shizuoka (JP); Yusuke HATANAKA, Shizuoka (JP)

(73) Assignee: FUJIFILM CORPORATION, Tokyo (JP)

(21) Appl. No.: 13/165,381

(22) Filed: Jun. 21, 2011

(30) Foreign Application Priority Data
Jun. 22, 2010 (JP) 2010-141260

(51) Int. Cl. B32B 3/26; C25D 5/48; C25D 5/02

(52) U.S. Cl. 428/304.4; 205/131

(57) ABSTRACT

A microstructure enabling provision of an anisotropic conductive member capable of reducing wiring defects and a method of producing such microstructure. The microstructure includes through-holes formed in an insulating matrix and filled with a metal and an insulating substance. The through-holes have a density of 1×10⁶ to 1×10¹⁰ holes/mm², a mean opening diameter of 10 nm to 5000 nm, and a mean depth of 10 μm to 1000 μm. The sealing ratio of the through-holes as attained by the metal alone is 80% or more, and the sealing ratio of the through-holes as attained by the metal and the insulating substance is 99% or more. The insulating substance is at least one kind selected from the group consisting of aluminum hydroxide, silicon dioxide, metal alkoxide, lithium chloride, titanium oxide, magnesium oxide, tantalum oxide, niobium oxide, and zirconium oxide.

### BACKGROUND OF THE INVENTION

The present invention relates to a microstructure and a microstructure production method.

Metal-filled microstructures (devices) where a metal is filled in micropores formed in a matrix are one of the fields in nano-technologies that have been attracting attention in recent years.

An anisotropic conductive member, when inserted between an electronic component such as a semiconductor device and a circuit board, then merely subjected to pressure, is able to provide an electrical connection between the electronic component and the circuit board. Accordingly, such members are widely used, for example, as electric connection members for electronic components such as semiconductor devices and as inspection connectors used to inspect the functions of such components.

In particular, given significant miniaturization of electronic connection members such as semiconductors, conventional methods such as wire bonding whereby circuit boards are directly connected can no longer permit further reduction of wire diameters.

Against such background, attention has been focused in recent years on anisotropic conductive members of a type in which an array of electrically conductive members are provided through the film of an insulating material, or of a type in which metal balls are arranged in the film of an insulating material.

Inspection connectors for inspecting semiconductors, for example, are used to avoid large monetary losses that would be incurred if a function inspection, carried out after an electronic component such as a semiconductor device has been mounted on a circuit board, should find the electronic component defective and the circuit board is discarded together with the electronic component.

That is, by bringing electronic components such as semiconductor devices into an electrical contact with a circuit board through an anisotropic conductive member at positions similar to those to be used during mounting and carrying out functional inspections, it is possible to perform the function inspections without mounting the electronic components on the circuit board, which enables the above problem to be avoided.

The present applicant proposed in JP 2009-283431 A “a microstructure, which may be used as an anisotropic conductive member, made of an insulating matrix comprising micropores having a density of 1×10⁶ to 1×10¹⁰/mm² and a diameter of 10 nm to 500 nm, wherein a metal is filled in the micropores to a filling ratio of 80% or more,” and, in JP 2010-33753 A, “a microstructure made of an insulating matrix having a density of 1×10⁶ to 1×10¹⁰/mm² and a diameter of 10 nm to 500 nm, wherein a metal is filled in 20% or more of the total number of the through-holes and a polymer is filled in 1% to 80% of the total number of the through-holes.

### SUMMARY OF THE INVENTION

The present inventors considered the microstructures described in JP 2009-283431 A and JP 2010-33753 A and found that when these microstructures are used as anisotropic conductive members, in particular electronic connection members for multi-layer circuit boards, wiring defects easily occur such as detachment of wiring (electrodes) and the like.

Accordingly, an object of the present invention is to provide a microstructure enabling provision of an anisotropic conductive member capable of reducing wiring defects and its production method.

The present inventors made a thorough study to achieve the above object, found that the wiring defects can be reduced by using as an anisotropic conductive member a microstructure wherein micropores formed in an insulating matrix are filled with a metal and an insulating substance to a given sealing ratio, and accomplished the present invention.

Specifically, the present invention provides the following (1) to (10).

(1) A microstructure comprising through-holes formed in an insulating matrix filled with a metal and an insulating substance,

wherein the through-holes have a density of 1×10⁶ to 1×10¹⁰ holes/mm², a mean opening diameter of 10 nm to 5000 nm, and a mean depth of 10 μm to 1000 μm,

wherein the sealing ratio of the through-holes as attained by the metal alone is 80% or more,

wherein the sealing ratio of the through-holes as attained by the metal and the insulating substance is 99% or more, and

wherein the insulating substance is at least one kind selected from the group consisting of aluminum hydroxide, silicon dioxide, metal alkoxide, lithium chloride, titanium oxide, magnesium oxide, tantalum oxide, niobium oxide, and zirconium oxide.

(2) The microstructure described in (1) above, wherein the aspect ratio of the through-holes (mean depth/mean opening diameter) is 100 or more.
(3) The microstructure described in (1) or (2) above, wherein the insulating matrix provided with the through-holes is an anodized film of a valve metal.
(4) The microstructure described in (3) above, wherein the valve metal is at least one kind of metal selected from the group consisting of aluminum, tantalum, niobium, titanium, hafnium, zirconium, zinc, tungsten, bismuth, and antimony.
(5) The microstructure described in (4) above, wherein the above valve metal is aluminum.
(6) The microstructure described in any one of (1) to (5) above, wherein the metal is at least one kind selected from the group consisting of copper, gold, aluminum, nickel, silver, and tungsten.
(7) A method of producing a microstructure described in any one of (1) to (6) above, comprising

a metal filling step of applying an electrolytic plating to the insulating matrix to fill the through-holes with the metal to a sealing ratio of 80% or more, and, following the metal filling step,

an insulating substance filling step of applying a sealing treatment to the insulating matrix filled with the metal to fill the insulating substance to a sealing ratio of 99% or more.

(8) The microstructure described in any one of (1) to (6) above, wherein the microstructure is used as anisotropic conductive member.
(9) A multi-layer circuit board comprising two or more layers of anisotropic conductive member,

wherein the anisotropic conductive member is the microstructure described in any one of (1) to (6).

10. The multi-layer circuit board according to claim 9 used as an interposer of a semiconductor package.

As will be described below, the present invention can provide a microstructure capable of reducing wiring defects and its production method.

### BRIEF DESCRIPTION OF THE DRAWINGS

FIGS. 1A and 1B are schematic views of an example of a conventional microstructure. FIG. 1A is a perspective view; FIG. 1B is a schematic view for explaining a cross section taken along the line IB-IB of FIG. 1A.

FIGS. 2A and 2B are schematic views of an example according to a preferred embodiment of the microstructure of the invention. FIG. 2A is a perspective view; FIGS. 2B and 2C are schematic views for explaining a cross section taken along the line IB-IB of FIG. 2A.

FIG. 3 is a view for explaining a method of calculating the density of micropores as through-holes.

### DETAILED DESCRIPTION OF THE INVENTION

### [Microstructure]

The present invention will now be described in detail below.

The microstructure of the invention is a microstructure of which the through-holes formed in an insulating matrix are filled with a metal and an insulating substance,

wherein the through-holes have a density of 1×10⁶ to 1×10¹⁰ holes/mm², a mean opening diameter of 10 nm to 5000 nm, and a mean depth of 10 μm to 1000 μm,

wherein the metal alone seals the through-holes to a sealing ratio of 80% or more and the metal and the insulating substance together seal the through-holes to a sealing ratio of 99% or more, and

wherein the insulating substance is at least one kind selected from a group consisting of aluminum hydroxide, silicon dioxide, metal alkoxide, and lithium chloride.

Next, the structure of the microstructure of the invention is described by reference to the drawings.

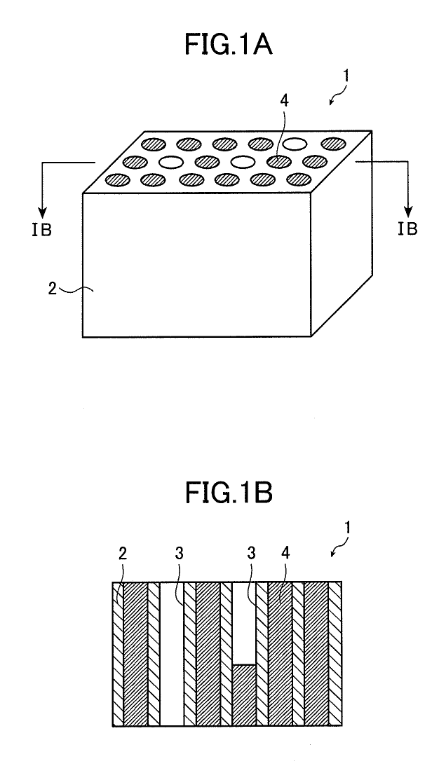

First, reference is made to FIG. 1 showing an example of a conventional microstructure.

Similarly to the microstructure of the invention, a conventional microstructure 1 is formed of an insulating matrix 2 having through-holes 3 filled with a metal 4 but, as illustrated in FIG. 1, had some through-holes that were not filled to any extent or others only filled to about a half of the depth thereof.

The present inventors found that the above problems of wiring defects in conventional microstructures are caused by through-holes not completely sealed and, moreover, the above problems of wiring defects are alleviated when a metal seals the through-holes to a sealing ratio of 80% or more and an insulating substance seals the through-holes to a final sealing ratio of 99% or more.

The sealing ratio (%) is a mean value calculated from the ratios of the number of through-holes sealed with a metal or an insulating substance to the number of all the through-holes within the field of view (sealed through-holes/all the through-holes) obtained by observing the top surface and the bottom surface of the microstructure with an FE-SEM.

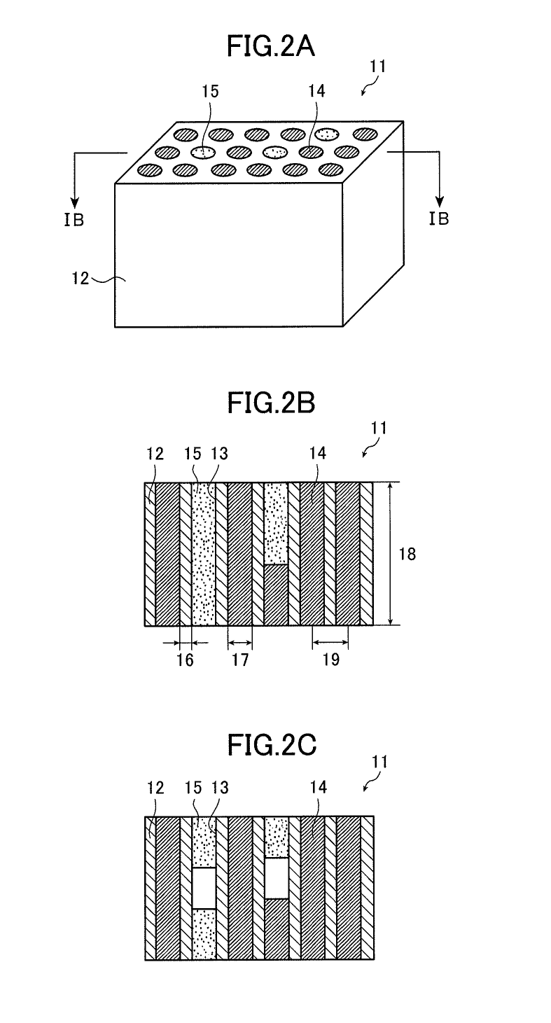

FIG. 2 is a schematic view illustrating an example of a preferred embodiment of the microstructure of the invention.

As illustrated in FIG. 2, a microstructure 11 of the invention is a microstructure of which through-holes 13 made in an insulating matrix 12 are filled with a metal 14 and an insulating substance 15.

FIGS. 2A to 2C illustrate states where the through-holes are filled by the metal 14 and the insulating substance 15 to a final sealing ratio of 100%. According to the invention, the through-holes 13 need not necessarily be completely filled as illustrated in FIG. 2C, provided that the through-holes 13 are sealed to a given sealing ratio.

In cases where the microstructure 11 of the invention is used as an anisotropic conductive member, the through-holes 13 filled with the metal 4 alone serve as conductive paths of an anisotropic conductive member.

Next, the materials and dimensions of the respective components of the microstructure of the invention will be described.

### <Insulating Matrix>

The insulating matrix of the microstructure of the invention is not specifically limited in any manner, provided that it has an electric resistivity of about 10¹⁴ Ω·cm, which is comparable to that of an insulating matrix of a conventionally known anisotropic conductive film (e.g., a thermoplastic elastomer).

According to the invention, the insulating matrix is preferably an anodized film of a valve metal because the insulating matrix has through micropores having a desired mean opening diameter and a high aspect ratio.

The valve metal is exemplified by aluminum, tantalum, niobium, titanium, hafnium, zirconium, zinc, tungsten, bismuth, and antimony.

Among these, an anodized film (matrix) of aluminum is preferred because it has a good dimensional stability and is relatively inexpensive.

According to the present invention, the interval between neighboring through-holes (the distance represented by reference symbol 16 in FIG. 2B) in the insulating matrix is preferably at least 10 nm, more preferably from 20 nm to 100 nm, and still more preferably from 20 nm to 50 nm.

With the interval provided between neighboring through-holes within the foregoing range, the insulating matrix functions sufficiently as an insulating barrier.

### <Through-Holes>

The through-holes provided in the insulating matrix of the invention are filled with a metal and an insulating substance described later to a given sealing ratio.

The sealing ratio attained by a metal alone described later, i.e., the rate obtained after the through-holes are filled with a metal and before it is filled with an insulating substance, is 80% or more, preferably 85% or more, and still more preferably 90% or more. That sealing ratio is preferably less than 99%.

The sealing ratio in the above range as attained by a metal alone means that many of the through-holes function also as conductive paths of an anisotropic conductive member.

The sealing ratio attained by a metal and an insulating substance described later, i.e., the rate obtained after the through-holes are filled with a metal and thereafter further filled with an insulating substance, is 99% or more, preferably 100%.

The sealing ratio in the above range as attained by a metal and an insulating substance enables provision of an anisotropic conductive member that permits wiring defects to be reduced.

This may be because fine dust, oil content, etc. (referred to below as “contamination”) originating from a constituent material (mainly liquid) of a wiring layer collect in unsealed through-holes during formation of a wiring layer on the anisotropic conductive member and this contamination adversely affects the contact with the wiring layer whereas the through-hole sealing ratio of 99% or more achieved using a given insulating substance as according to the invention reduces the degree of such contamination.

According to the invention, the through-holes have a density of 1×10° to 1×10¹⁰ holes/mm², preferably 2×10⁶ to 8×10⁹ holes/mm², and more preferably 5×10⁶ to 5×10⁹ holes/mm².

With the density of the through micropores within the foregoing range, the microstructure of the invention can be used as an inspection connector or the like for electronic components such as semiconductor devices even today when ever higher levels of integration are being achieved in semiconductors and other like electronic components.

The mean opening diameter (portion indicated by a reference symbol 17 in FIG. 2B) is 10 nm to 5000 nm, preferably 10 nm to 3000 nm, more preferably 10 nm to 1000 nm, and still more preferably 20 nm to 1000 nm.

With the mean opening diameter of the through-holes within the foregoing range, when an electric signal is applied, sufficient responses are obtained, and the microstructure of the invention can be suitably used as an inspection connector for inspecting electronic components.

The mean depth of the through-holes (portion indicated by a reference symbol 18 in FIG. 2B) is 10 nm to 1000 μm, preferably 50 μm to 700 μm, and more preferably 50 μm to 200 μm.

The mean depth of the through-holes or the thickness of the insulating matrix within the above range provides an increased mechanical strength and increases the ease of handling of the insulating matrix.

According to the present invention, the aspect ratio of the through-holes (mean depth/mean opening diameter) is preferably 100 or more, more preferably 100 to 100000, and still more preferably 200 to 10000.

The center-to-center spacing between the adjacent through-holes (portion indicated by reference numeral 19 in FIG. 2B and referred to also as “period” below) is 20 nm to 5000 nm, more preferably from 30 nm to 500 nm, still more preferably 40 nm to 200 nm, and most preferably 50 nm to 140 nm.

The period within the above range makes it easier to provide a balance between the mean opening diameter of the through-holes and the intervals between the through-holes (thickness of the insulating barriers).

The degree of ordering defined by the following formula (i) for the through-holes is preferably 50% or more for an increased density of the through-holes.

Degree of ordering(%)=B/A×100 (i)

In the above formula (i), A represents a total number of through-holes in a region of measurement and B represents a number of specific through-holes in the region of measurement for which, when a circle is drawn so as to be centered on a center of gravity of a specific through-hole and so as to be of a smallest radius that is internally tangent to an edge of another through-hole, the circle includes centers of gravity of six through-holes other than the specific through-hole.

More specific explanation for calculating the degree of ordering of the through-holes is given in JP 2009-132974 A.

### [Metal]

The metal forming a part of the microstructure of the invention is not particularly limited, provided it has an electric resistivity of 10³ Ω·cm or less. Preferred examples thereof include gold (Au), silver (Ag), copper (Cu), aluminum (Al), magnesium (Mg), nickel (Ni), molybdenum (Mo), iron (Fe), palladium (Pd), beryllium (Be), rhenium (Re) and tungsten (W). One kind of these may be filled alone or an alloy of two or more of these may be filled.

From a viewpoint of electric conductivity, copper, gold, aluminum, nickel, silver, and tungsten among them are preferable, and copper and gold are more preferable.

### <Insulating Properties>

The insulating substance forming a part of the microstructure of the invention is at least one kind selected from the group consisting of aluminum hydroxide, silicon dioxide, metal alkoxide, lithium chloride, titanium oxide, magnesium oxide, tantalum oxide, niobium oxide, and zirconium oxide.

Among them, aluminum hydroxide, silicon dioxide, metal alkoxide, and lithium chloride are preferable for their excellent insulation; when the insulating matrix is an anodized film of aluminum, aluminum hydroxide is particularly preferable for its excellent adsorptivity with aluminum oxide.

Metal alkoxide may be, for example, one exemplified in a sealing treatment (sol-gel method) described later.

### [Method of Producing the Microstructure of the Invention]

The manufacturing method of the microstructure of the invention will be described below in detail.

The microstructure production method of producing the microstructure of the invention (hereinafter also referred to simply as “production method of the invention” below) comprises a metal filling step of filling the metal into the through-holes to a sealing ratio of 80% or more and, after the metal filling step, an insulating substance filling step of applying a sealing treatment to the insulating matrix filled with the metal to further fill the insulating substance to a sealing ratio of 99% or more.

Next, these steps in the production method of the invention will be described.

### <Production of Insulating Matrix>

The method of producing the insulating matrix is preferably a method whereby the valve metal undergoes anodizing treatment as described above. For example, when the insulating matrix is an anodized film of aluminum, the insulating matrix may be produced by an anodizing treatment for anodizing an aluminum substrate and, after this anodizing treatment, a perforating treatment for causing the micropores made by the anodization to perforate the substrate, these treatments being effected in this order.

According to the invention, the aluminum substrate used to produce the insulating matrix and the treatments applied to the aluminum substrate may be similar to those described in passages to [0121] of JP 2008-270158 A.

### [Metal Filling Step]

The metal filling step is performed to apply electrolytic plating treatment to the insulating matrix and filling the through-holes with the metal to a sealing ratio of 80% or more. The electrolytic plating is preferably preceded by an electrode film formation treatment for forming an electrode film free of a gap on a surface of one side of the insulating matrix, and the electrolytic plating is preferably followed by a surface smoothing treatment.

According to the invention, the electrode film formation treatment, the electrolytic plating treatment, and the surface smoothing treatment may be similar to those described in passages [0069] to [0080] of JP 2009-283431 A.

According to the present invention, the electrolytic plating treatment enables the metal to be filled into the through-holes to a high filling ratio in the depth direction so that many of the through-holes can function also as conductive paths in the anisotropic conductive member. Therefore, the electrolytic plating treatment as performed in the present invention is preferably achieved by implementing treatments A and B in this order as follows.

### [Electrolytic Plating Treatment A]

An electrolytic plating treatment for filling the through-holes to 0.01% to 1% of the depth of the through-holes, whereby the heights of the metal filled into the through-holes (referred to as “filled metal height” below) are contained within 30% of a mean value thereof.

### [Electrolytic Plating Treatment B]

An electrolytic plating treatment performed with a lower current density than in the electrolytic plating treatment A.

The conditions for the electrolytic plating treatment A may be determined as follows.

Specifically, the depth of the through-holes before treatment is measured first, and electrolytic plating treatment is applied under given conditions to an insulating matrix formed with through-holes having the same depth as the depth obtained by the measuring while varying the plating voltage, the current density, the plating time, etc., followed by sampling.

Next, the microstructure thus treated is allowed to undergo FIB cutting, and the cut surface thereof is observed with an FE-SEM.

Then, samples in which the filled metal height is in a range of 0.01% to 1% of the through-hole depth are selected to observe the filled metal height at a given number of holes and thereby calculate a mean value of the filled metal heights.

Subsequently, the individual through-holes are measured for the filled metal height to obtain their respective differences from the mean value and determine plating conditions under which the differences fall within 30% of the mean value of the filled metal heights.

The electrolytic plating treatment B is performed with a lower current density than the electrolytic plating treatment A; when the electrolytic plating treatment A has been performed with a varied current density, the electrolytic plating treatment B is performed at a current density that is still lower than the mean value of the varied current density.

The ratio by which the current density is lowered is not limited and is preferably ¾ to ¼ and more preferably ½ to 1/20.

### <Insulating Substance Filling Step>

The insulating substance filling step follows the metal filling step and comprises applying a sealing treatment to the insulating matrix filled with the metal and further filling the insulating substance to a sealing ratio of 99%.

The sealing treatment in the insulating substance filling step may be performed by any of known methods including boiling water treatment, hot water treatment, steam treatment, sodium silicate treatment, nitrite treatment, and ammonium acetate treatment. The sealing treatment may be performed, for example, with any of the devices and by any of the methods described in JP 56-12518 B, JP 4-4194 A, JP 5-202496 A, and JP 5-179482 A.

In the present invention, the treatment liquid used in boiling water treatment, hot water treatment, sodium silicate treatment, and the like is allowed to penetrate the through-holes (a portion thereof where the metal has not been filled; the same applies to the following descriptions related to the sealing treatment), and the substance forming the inner wall of the through-holes (e.g., aluminum oxide) is altered (e.g., into aluminum hydroxide, thereby to achieve sealing of the through-holes.

Other preferred examples of the sealing treatment include one using a sol-gel method as described in JP 06-35174 A, passages [0016] to [0035].

The sol-gel method is generally a method whereby a sol is altered into a gel, which has no fluidity, through hydrolysis and polycondensation reaction, and the gel is then heated to produce an oxide.

The metal alkoxide is not specifically limited and, from a viewpoint of ease with which the through-holes are sealed, preferred examples thereof include Al(O—R)n, Ba(O—R)n, B(O—R)n, Bi(O—R)n, Ca(O—R)n, Fe(O—R)n, Ga(O—R)n, Ge(O—R)n, Hf(O—R)n, In(O—R)n, K(O—R)n, La(O—R)n, Li(O—R)n, Mg(O—R)n, Mo(O—R)n, Na(O—R)n, Nb(O—R)n, Pb(O—R)n, Po(O—R)n, Po(O—R)n, P(O—R)n, Sb(O—R)n, Si(O—R)n, Sn(O—R)n, Sr(O—R)n, Ta(O—R)n, Ti(O—R)n, V(O—R)n, W(O—R)n, Y(—R)n, Zn(O—R)n, and Zr(O—R)n. Among the above examples,

R represents a linear, branched, or cyclic hydrocarbon group that may have a substituent or a hydrogen atom; n is any natural number.

Among the above examples, when the insulating matrix is an anodized film of aluminum, titanium oxide or silicon oxide-based metal alkoxide is preferably used for their excellent reactivity with aluminum oxide and excellent sol-gel forming capability.

Formation of a sol-gel in the through-holes may be effected by any method as appropriate but, from a viewpoint of ease with which filling into the through-holes for sealing can be achieved, is preferably achieved by a method whereby a sol-gel liquid is applied and heated.

The concentration of the sol liquid is preferably 0.1 mass % to 90 mass %, more preferably 1 mass % to 80 mass %, and most preferably 5 mass % to 70 mass %.

To increase the sealing ratio, the treatments may be repeated on one another.

In an alternative sealing treatment, insulating particles of a size that can enter the through-holes may be filled in the through-holes.

Such insulating particles are preferably made of colloidal silica for its dispersibility and size.

Colloidal silica may be produced by a sol-gel method or procured from the market. To produce colloidal silica by a sol-gel method, reference may be had, for example, to Werner Stober et al; J. Colloid and Interface Sci., 26, 62-69 (1968), Rickey D. Badley et al; Lang muir 6, 792-801 (1990), JOURNAL OF THE JAPAN SOCIETY OF COLOUR MATERIAL, 61 [9] 488-493 (1988).

Colloidal silica is a dispersion of silica composed of silicon dioxide as a basic unit in water or a water-soluble solvent. The particle diameter thereof is preferably 1 nm to 400 nm, more preferably 1 nm to 100 nm, and most preferably 5 nm to 50 nm. Particles thereof having a smaller diameter than 1 nm reduce storage stability of the applied liquid; particles thereof having a greater diameter than 400 nm reduce the ease with which the applied liquid is filled into the through-holes.

The colloidal silica having a particle diameter in the above range is in a state of aqueous dispersion liquid and may be used whether it is basic or acidic.

Examples of acidic colloidal silica of which the dispersive medium is water which may be used herein include SNOWTEX (trademark; the same applies below)-O and SNOWTEX-OL produced by Nissan Chemical Industries, Ltd.; ADELITE (trademark; the same applies below) AT-20Q, produced by ADEKA Corporation; Klebosol (trademark; the same applies below) 20H12 and Klebosol 30CAL25 produced by Clariant (Japan) K.K.; and other commercially available products.

Among basic colloidal silica are silica that gains stability when added with alkali metal ion, ammonium ion, or amine, and examples of such silica include SNOWTEX-20, SNOWTEX-30, SNOWTEX-C, SNOWTEX-C30, SNOWTEX-CM40, SNOWTEX-N, SNOWTEX-N30, SNOWTEX-K, SNOWTEX-XL, SNOWTEX-YL, SNOWTEX-ZL, SNOWTEXPS-M, and SNOWTEXPS-L produced by Nissan Chemical Industries, Ltd.; ADELITE AT-20, ADELITE AT-30, ADELITE AT-20N, ADELITE AT-30N, ADELITE AT-20A, ADELITE AT-30A, ADELITE AT-40, and ADELITE AT-50 produced by ADEKA Corporation; Klebosol 30R9, Klebosol 30R50, Klebosol 50R50 produced by Clariant (Japan) K.K.; Ludox (trademark: the same applies below) HS-40, Ludox HS-30, Ludox LS, and Ludox SM-30 produced by E.I. du Pont de Nemours and Company, and other commercially available products.

Examples of colloidal silica of which the dispersive medium is a water-soluble solvent which may be used herein include MA-ST-M (particle diameter: 20 to 25 nm, methanol-dispersed type), IPA-ST (particle diameter: 10 to 15 nm, isopropyl alcohol-dispersed type), EG-ST (particle diameter: 10 to 15 nm, ethylene glycol-dispersed type), EG-ST-ZL (particle diameter: 70 to 100 nm, ethylene glycol-dispersed type), NPC-ST (particle diameter: 10 to 15 nm, ethylene glycol monopropyl ether-dispersed type) produced by Nissan Chemical Industries, Ltd., and other commercially available products.

These kinds of colloidal silica may be used alone or in combination of two or more kinds thereof and may contain a trace amount of, for example, alumina or sodium aluminate.

Further, colloidal silica may contain, for example, inorganic base (e.g., sodium hydroxide, potassium hydroxide, lithium hydroxide, and ammonia) and organic base (e.g., tetramethyl ammonium) as stabilizer.

There are cases where the surface of the insulating matrix is covered by the insulating substance when the through-holes are sealed in the insulating substance filling step according to the invention. In such cases, the insulating substance covering the surface of the insulating matrix is preferably removed so that many of the through-holes may function as conductive paths of the anisotropic conductive member.

The insulating substance covering the surface of the insulating matrix may be removed by any methods as appropriate, preferred examples thereof including precision polishing treatment (mechanical polishing treatment) and chemical-mechanical polishing (CMP) treatment; enzyme plasma treatment; and immersion treatment using, for example, an alkaline aqueous solution such as sodium hydroxide aqueous solution and an acidic aqueous solution such as sulfuric acid to remove only the superficial layer portion of the insulating matrix.

The microstructure of the invention may be preferably used as anisotropic conductive member described in, for example, JP 2008-270157 A and may be preferably used as anisotropic conductive member (anisotropic conductive film) in a multi-layer circuit board used as an interposer for a semiconductor package.

### EXAMPLES

The present invention is described below more specifically by way of examples. The present invention should not be construed as being limited to the following examples.

### Examples 1 to 8

### (A) Mirror Finish Treatment (Electrolytic Polishing)

A high-purity aluminum substrate (purity 99.99 mass %, thickness 0.4 mm, produced by Sumitomo Light Metal Industries, Ltd.) was cut to an area of 10 cm×10 cm for anodization and allowed to undergo an elctrolytic polishing treatment with a voltage of 25 V at a liquid temperature of 65° C. and at a liquid flow rate of 3.0 m/min using an electrolytic polishing solution having the following composition.

A carbon electrode was used as cathode, and a GP0110-30R unit (Takasago, Ltd.) was used as power supply. In addition, the flow rate of the electrolytic solution was measured using the FLM22-10PCW vortex flow monitor manufactured by As One Corporation.

### (Electrolytic Polishing Solution Composition)

| | | |
|---|---|---|
| 85 mass % Phosphoric acid (Wako Pure Chemical | 660 | mL |
| Industries, Ltd.) | | |
| Pure water | 160 | mL |
| Sulfuric acid | 150 | mL |
| Ethylene glycol | 30 | mL |

### (B) Anodizing Treatment

After electrolytic polishing, the aluminum substrate was subjected to self-ordering anodizing treatment according to the procedure described in JP 2007-204802 A.

After the electrolytic polishing treatment, the aluminum substrate was subjected to a 5-hour pre-anodizing treatment with a voltage of 40 V at a liquid temperature of 15° C. and at a liquid flow rate of 3.0 m/min using an electrolytic solution of 0.50-mol/L oxalic acid.

Following the pre-anodizing treatment, the aluminum substrate was immersed in a mixed aqueous solution (liquid temperature: 50° C.) of 0.2-mol/L chromic anhydride and 0.6-mol/L phosphoric acid in a 12-hour film removal treatment.

Thereafter, aluminum substrate was subjected to a 16-hour re-anodizing treatment with a voltage of 40 V at a liquid temperature of 15° C. and at a liquid flow rate of 3.0 m/min using an electrolytic solution of 0.50-mol/L oxalic acid to obtain a 130-μm thick anodized film.

Preliminary anodizing treatment and re-anodizing treatment were both applied using a stainless steel electrode as cathode and a GP0110-30R unit (produced by Takasago, Ltd.) as power supply. Use was made of NeoCool BD36 (produced by Yamato Scientific Co., Ltd.) as a cooling system, and Pairstirrer PS-100 (produced by Tokyo Rikakikai Co., Ltd.) as a stirring and warming unit. In addition, the flow rate of the electrolytic solution was measured using a vortex flow monitor FLM22-10PCW (produced by As One Corporation).

### (3) Perforating Treatment

Next, the aluminum substrate was immersed in a 20-mass % aqueous solution of mercuric chloride (corrosive sublimate) at 20° C. for 3 hours and dissolved, followed by a 30-minute immersion in 5-mass % phosphoric acid at 30° C. to remove a bottom portion of the oxide film and produce an oxide film having through micropores.

The mean pore diameter of the through micropores was 30 nm. The mean pore diameter was obtained by photographing the surface with an FE-SEM at 50000-fold magnification and measuring 50 points to calculate a mean value therefrom.

The mean pore depth of the through micropores was about 130 μm. The mean pore depth was obtained as follows. The microstructure obtained in the above procedure was cut through micropores in thickness direction with an FIB, the cross section surface was photographed with an FE-SEM at 50000-fold magnification, and 10 points were measured to calculate a mean value therefrom.

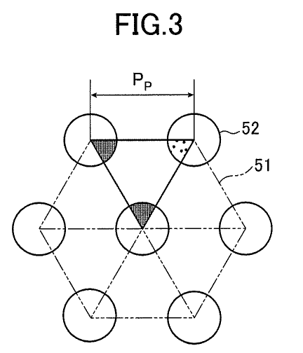

The density of the through micropores was 150 million micropores/mm². The density was calculated using the following formula based on an assumption that a unit lattice 51 of the micropores arranged so that the degree of ordering defined by the formula (i) given earlier herein is 50% or more contains ½ the number of micropores 52 as illustrated in FIG. 3. In the following formula, Pp is the period of the micropores.

Density(micropores/m²)=(½ the number of micropores)/{Pp(μm)×Pp(μm)×\sqrt{3}×(½)}

The through micropores had a degree of ordering of 92%. The degree of ordering of the micropores as defined by the above formula (i) was measured by photographing the surface at 20000-fold magnification with an FE-SEM in a 2 μm×2 μm field of view.

### (D) Heating Treatment

Then, the perforated structure obtained as above was subjected to a 1-hour heating treatment at 400° C.

### (E) Electrode Film-Forming Treatment

A treatment was then applied to form an electrode film on one surface of the perforated structure having undergone the above-described heating treatment.

To be more specific, an aqueous solution of 0.7 g/L chloroauric acid was applied to one surface, dried at 140° C. for 1 minute, and baked at 500° C. for 1 hour to form gold plating nuclei.

Then, PRECIOUSFAB ACG2000 base solution/reducing solution (produced by Electroplating Engineers of Japan Ltd.) was used as electroless plating solution to effect immersion at 50° C. for one hour to form an electrode film having no gap between itself and the surface.

### (6) Metal Filling Step (Electrolytic Plating)

Next, a copper electrode was placed in close contact with the surface having the electrode film formed thereon, and electrolytic plating was carried out using the copper electrode as cathode and platinum as anode.

A constant-current electrolysis was effected using a copper plating solution or a nickel plating solution having a composition as given below to produce a microstructure having its through micropores filled with copper or nickel.

An electroplating system manufactured by Yamamoto-MS Co., Ltd. and a power supply (HZ-3000) manufactured by Hokuto Denko Corp. were used to carry out constant-current electrolysis. The deposition potential was checked by cyclic voltammetry conducted in the plating solution, followed by the electrolysis effected under the following conditions.

### <Copper Plating Solution>

| | | |
|---|---|---|
| Copper sulfate | 100 | g/L |
| Sulfuric acid | 50 | g/L |
| Hydrochloric acid | 15 | g/L |
| Temperature | 25° | C. |
| Current density | 10 | A/dm² |

### <Nickel Plating Solution>

| | | |
|---|---|---|
| Nickel sulfate | 300 | g/L |
| Nickel chloride | 60 | g/L |
| Boric acid | 40 | g/L |
| Temperature | 50° | C. |
| Current density | 5 | A/dm² |

### (7) Precision Polishing

Then, mechanical polishing treatment was applied to both sides of the microstructure thus produced to obtain a 110-μm thick microstructure.

As the sample holder used in mechanical polishing, a ceramic tool (manufactured by Kemet Japan Co., Ltd.) was employed and as a material for bonding to the sample holder, ALCOWAX (manufactured by Nikka Seiko Co., Ltd.) was employed. As an abrasive, DP-suspension P-6 μm, P-3 μm, P-1 μm, and P-¼ μm (produced by Struers) were used in sequence.

The sealing ratio of the through-holes of the micropores filled yet with the metal alone thus produced (referred to as “metal filled microstructure” below) was measured.

Specifically, both sides of the produced metal filled microstructure were observed with an FE-SEM to determine whether each of the 1000 through-holes was sealed or not, and their sealing rates were obtained to calculate a mean value from the sealing rates on both sides. The results are shown in Table 1.

The produced metal filled microstructure was cut with FIB in thickness direction, and the cross section was photographed with an FE-SEM at 50000-fold magnification. Observation of the inside of the through-holes revealed that the through-holes were completely filled with the metal.

### (8) Insulating Substance Filling Step

Then, the metal filled microstructure produced as above was subjected to any one of sealing treatments A to F described later to produce a microstructure. The kinds of the sealing treatment applied in the respective examples are shown in Table 1.

### Sealing Treatment A

The metal filled microstructure was immersed in pure water at 80° C. for 1 minute and, as immersed, heated in a 110° C. atmosphere for 10 minutes.

### Sealing Treatment B

The metal filled microstructure was immersed in pure water at 60° C. for 1 minute and, as immersed, heated in a 130° C. atmosphere for 25 minutes.

### Sealing Treatment C

The metal filled microstructure was immersed in a 5% aqueous solution of lithium chloride at 80° C. for 1 minute and, as immersed, heated in a 110° C. atmosphere for 10 minutes.

### Sealing Treatment D

The metal filled microstructure was exposed to a 100° C./500 kPa steam for 1 minute.

### Sealing Treatment E

The metal filled microstructure was immersed in a 25° C. treatment liquid A (see the following description) for 15 minutes and then heated in a 500° C. atmosphere for 1 minute.

### (Treatment Liquid A)

| | |
|---|---|
| Titanium tetraisopropoxide | 50.00 g |
| Concentrated nitric acid | 0.05 g |
| Pure water | 21.60 g |
| Methanol | 10.80 g |

### Sealing Treatment F

The metal filled microstructure was immersed in a 25° C. treatment liquid B (see the following description) for 1 hour.

### (Treatment Liquid B)

| | |
|---|---|
| Colloidal silica having a diameter of 20 nm (MA-ST-M | 0.01 g |
| produced by Nissan Chemical Industries, Ltd.) | |
| xethanol | 100.00 g |

### (9) Precision Polishing

Then, the same mechanical polishing treatment as in the above precision polishing treatment (7) was applied to both sides of the microstructure after the sealing treatment to obtain a 100-μm thick microstructure.

### Comparative Examples 1 and 2

Comparative examples 1 and 2 of a 100-μm thick microstructure are produced respectively by the same methods as in Examples 1 and 7 except that the sealing treatment was not effected.

### Comparative Example 3

A 100-μm thick microstructure was produced by the same method as in Example 1 except that the sealing treatment A was replaced by the following sealing treatment (polymer filling treatment) (G) described in JP 2010-33753 A.

### Sealing Treatment (G)

First, the metal filled microstructure was immersed in an immersion liquid having the following composition, followed by 1-minute drying at 140° C.

Then, 850-nm IR was applied to form a 5-μm thick polymer layer in the through-holes.

This treatment was thereafter repeated 19 times.

Composition of Immersion Liquid

| | |
|---|---|
| Radical polymerizable monomer (represented by general | 0.4120 g |
| formula C below) | |
| Photothermal conversion agent (represented by general | 0.0259 g |
| formula D below) | |
| Radical generator (represented by general formula E below) | 0.0975 g |
| 1-Methoxy-2-propanol | 3.5800 g |
| Methanol | 1.6900 g |

[Chemical Formula 1]

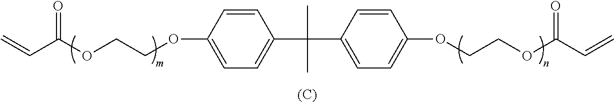

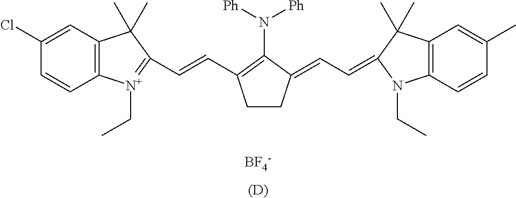

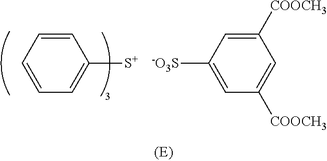

The sealing rates of Examples 1 to 8 and Comparative Example 3 of microstructure produced as described above were measured by the same method as used with the metal filled microstructure described above. The results are shown in Table 1.

TABLE 1

| | | Sealing | | | |
|---|---|---|---|---|---|
| | | ratio | | | Sealing ratio (%) |
| | Filled | (%) | Sealing | | (metal + Insulating |
| | metal | (metal) | treatment | Insulating substance | substance) |
| Example 1 | Cu | 92.6 | (A) | aluminium hydroxide | 100 |
| Example 2 | Cu | 92.6 | (B) | aluminium hydroxide | 100 |
| Example 3 | Cu | 92.6 | (C) | lithium chloride | 99.2 |
| Example 4 | Cu | 92.6 | (D) | aluminium hydroxide | 99.7 |
| Example 5 | Cu | 92.6 | (E) | metal alkoxide | 99.5 |
| Example 6 | Cu | 92.6 | (F) | silicon dioxide | 99.0 |
| Example 7 | Ni | 96.2 | (A) | aluminium hydroxide | 100 |
| Example 8 | Ni | 96.2 | (B) | aluminium hydroxide | 100 |
| Comparative | Cu | 92.6 | None | None | — |
| example 1 | | | | | |
| Comparative | Ni | 96.2 | None | None | — |
| example 2 | | | | | |
| Comparative | Cu | 92.6 | (G) | Polymer | 99.0 |
| example 3 | | | | | |

As is apparent from the results shown in Table 1, the electrolytic plating treatment and the sealing treatment enable a microstructure to be obtained wherein through-holes formed in an insulating matrix are filled with a metal and an insulating substance to a given sealing ratio.

A mask was used to form a given wiring pattern on the surface of the microstructures produced in Examples 1 to 8 and Comparative Example 3, and then the microstructures were immersed in an electroless gold plating bath (PRECIOUS HUB ACG2000 produced by TANAKA KIKINZOKU KOGYO K.K.) to produce structures wherein the wiring patterns were exposed on the surfaces of the respective microstructures.

Evaluation of the adhesion between the microstructure and the wiring pattern in the produced structures showed that the adhesion in the microstructure produced in Comparative Example 3 was poor. This is thought to be attributable to the electroless plating solution being repelled near the through-holes sealed by the hydrophobic polymer.

On the other hand, the microstructures produced in Examples 1 to 8 each have an excellent adhesion and are capable of reducing wiring defects when they are used as an anisotropic conductive member.

What is claimed is:

1. A microstructure comprising through-holes formed in an insulating matrix filled with a metal and an insulating substance,
wherein the through-holes have a density of 1×10⁶ to 1×10¹⁰ holes/mm², a mean opening diameter of 10 nm to 5000 nm, and a mean depth of 10 μm to 1000 μm,
wherein the sealing ratio of the through-holes as attained by the metal alone is 80% or more,
wherein the sealing ratio of the through-holes as attained by the metal and the insulating substance is 99% or more, and
wherein the insulating substance is at least one kind selected from the group consisting of aluminum hydroxide, silicon dioxide, metal alkoxide, lithium chloride, titanium oxide, magnesium oxide, tantalum oxide, niobium oxide, and zirconium oxide.

2. The microstructure according to claim 1, wherein the aspect ratio of the through-holes (mean depth/mean opening diameter) is 100 or more.

3. The microstructure according to claim 1, wherein the insulating matrix provided with the through-holes is an anodized film of a valve metal.

4. The microstructure according to claim 3, wherein the valve metal is at least one kind of metal selected from the group consisting of aluminum, tantalum, niobium, titanium, hafnium, zirconium, zinc, tungsten, bismuth, and antimony.

5. The microstructure according to claim 4, wherein the valve metal is aluminum.

6. The microstructure according to claim 1, wherein the metal is at least one kind selected from the group consisting of copper, gold, aluminum, nickel, silver, and tungsten.

7. A method of producing a microstructure described in claim 1, comprising
a metal filling step of applying an electrolytic plating to the insulating matrix to fill the through-holes with the metal to a sealing ratio of 80% or more, and
following the metal filling step, an insulating substance filling step of applying a sealing treatment to the insulating matrix filled with the metal to fill the insulating substance to a sealing ratio of 99% or more.

8. The microstructure according to claim 1, wherein the microstructure is used as anisotropic conductive member.

9. A multi-layer circuit board comprising two or more layers of anisotropic conductive member,
wherein the anisotropic conductive member is the microstructure described in claim 1.

10. The multi-layer circuit board according to claim 9 used as an interposer for a semiconductor package.
